(19) United States
(12) Patent Application Publication
(10) Pub. No.: US 2004/0100725 A1
(43) Pub. Date: May 27, 2004

(54) Damped disk spacer

(76) Inventors: Shiao-Hua Chen, Palo Alto, CA (US); Joseph Chang, San Jose, CA (US); Yun Han, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 10/302,174

(22) Filed: Nov. 21, 2002

(51) Int. Cl. G11B 17/08

(52) U.S. Cl. 360/98.08

(57) ABSTRACT

A spacer assembly for a spindle motor of a hard disk drive. The spacer assembly separates a first disk from a second disk of the disk drive. The spacer assembly includes a first layer of damping material located between a washer and a spacer. The first layer of damping material damps vibration that is transmitted through the spacer assembly and into the disk. Damping vibration reduces track mis-registration in the disk drive due to mechanical vibration.

### BACKGROUND OF THE INVENTION

1. Field of the Invention

The present invention relates to a spacer assembly for a spindle motor of a hard disk drive.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure arm to create a subassembly commonly referred to as a head gimbal assembly (“HGA”). The HGA's are attached to an actuator arm which has a voice coil motor that can move the heads across the surfaces of the disks.

Information is stored in radial-tracks that extend across the surfaces of each disk. Each track is typically divided up into a number of segments or sectors. The voice coil motor and actuator arm can move the heads to different tracks of the disks.

The disks are rotated by a spindle motor that is mounted to a base plate of the drive. The disks are typically mounted to a motor hub of the spindle motor by a clamp assembly. The disks are separated by disk spacers. Vibration within the disk drive can transmit through the motor hub, spacers and into the disks. The vibration may cause track mis-registration that degrades the performance of the disk drive. It would be desirable to reduce track mis-registration due to mechanical vibration within the disk drive.

### BRIEF SUMMARY OF THE INVENTION

A hard disk drive with a disk spacer assembly that includes a first layer of damping material located between a washer and a spacer.

### BRIEF DESCRIPTION OF THE DRAWINGS

FIG. 1 is a top view of an embodiment of a hard disk drive of the present invention;

FIG. 2 is a side sectional view of a spindle motor/disk assembly;

FIG. 3 is an enlarged side sectional view showing a spacer assembly.

### DETAILED DESCRIPTION OF THE PREFERRED EMBODIMENT

Disclosed is a spacer assembly for a spindle motor of a hard disk drive. The spacer assembly separates a first disk from a second disk of the disk drive. The spacer assembly includes a first layer of damping material located between a washer and a spacer. The first layer of damping material damps vibration that is transmitted through the spacer assembly and into the disk. Damping vibration reduces track mis-registration in the disk drive due to mechanical vibration.

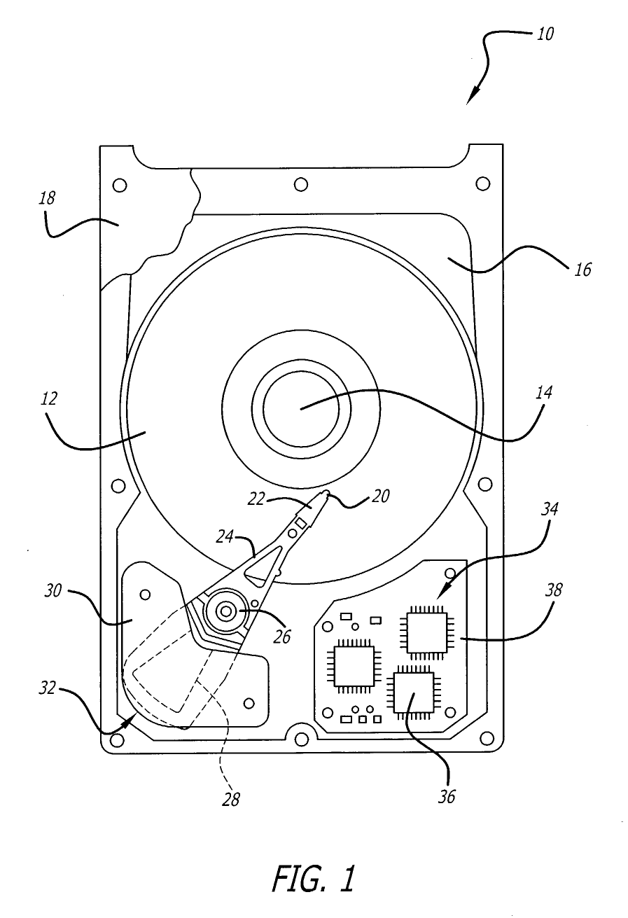

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

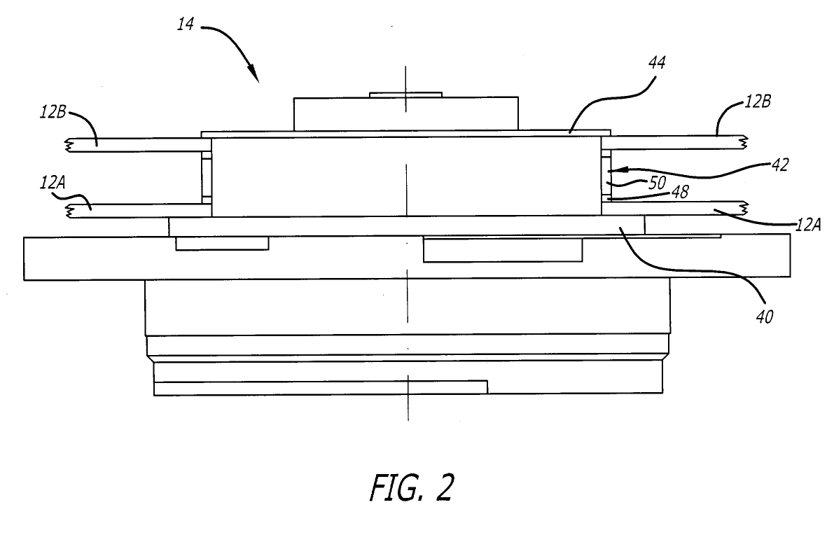

FIG. 2 shows an embodiment of the present invention wherein a first disk 12A and a second disk 12B are mounted to a hub 40 of the spindle motor 14. The disks 12A and 12B may be separated by a spacer assembly 42. The disks 12A and 12B and spacer assembly 42 may be pressed onto the hub 40 by a clamp assembly 44.

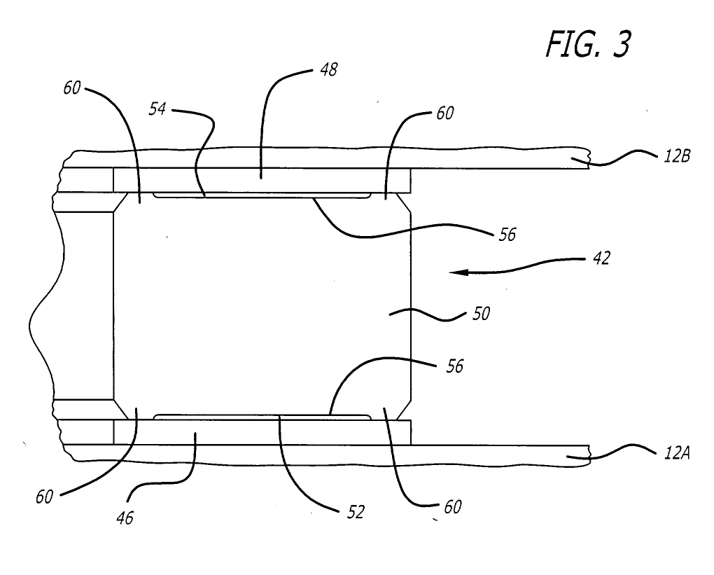

As shown in FIG. 3, the spacer assembly 42 may include a first washer 46 located adjacent to the first disk 12A and a second washer 48 located adjacent to the second disk 12B. The washers 46 and 48 are located at opposite ends of a spacer 50. By way of example, the washers 46 and 48 may be constructed from aluminum.

The spacer assembly 42 includes a first layer of damping material 52 located between the first washer 46 and the spacer 50. The assembly 42 may also include a second layer of damping material 54 located between the second washer 48 and the spacer 50. The damping layers 52 and 54 may be located in corresponding grooves 56 of the spacer 50. Each damping layer 52 and 54 preferably has a thickness that is greater than the depth of a groove 56 so that the layers 52 and 54 are deflected when assembled onto the motor hub 40. This insures that the damping material is in contact with the spacer 50 and the washers 46 and 48. By way of example, the grooves 56 may each be 0.004 inches deep, while each layer of damping material may be 0.006 inches thick in an undeflected state.

The layers of damping material 52 and 54 are preferably constructed from a viscoelastic material that will damp mechanical vibration that transmits through the motor hub 40 and into the spacer assembly 42. Damping the vibration will reduce track mis-registration due to mechanical vibration within the disk drive. To minimize the complexity and cost of assembly, the washers 46 and 48 may have the same inner and outer diameters as the spacer 50.

The inner and outer edges 60 of the spacer 50 may provide a hard stop to tighten the clamp assembly 44. Without the edges 60, the clamp force may be reduced over time as the viscoelastic damping material of the space 50 tends to relax.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, although two washers 46 and 48 are shown and described, the spacer assembly may have only one washer in contact with a disk.

What is claimed is:

1. A disk spacer assembly for a spindle motor of a hard disk drive, comprising:
a spacer;
a first washer; and,
a first layer of damping material located between said spacer and said washer.

2. The assembly of claim 1, further comprising a second washer and a second layer of damping material located between said spacer and said second washer.

3. The assembly of claim 1, wherein said first layer of damping material is located within a groove of said spacer.

4. The assembly of claim 3, wherein said first layer of damping material has an undeflected thickness that is greater than a depth of said groove.

5. The assembly of claim 1, wherein said spacer has an outer diameter that is approximately equal to an outer diameter of said washer.

6. The assembly of claim 1, wherein said first layer of damping material is constructed from a viscoelastic material.

7. A hard disk drive, comprising:
a base plate;
a spindle motor attached to said base plate;
a first disk;
a second disk;
a spacer assembly that separates said second disk from said first disk, said spacer assembly including;
a spacer;
a first washer; and,
a first layer of damping material located between said spacer and said washer;
an actuator arm attached to said base plate;
a head attached to said actuator arm and coupled to said disk;
a voice coil motor attached to said actuator arm.

8. The hard disk drive of claim 7, wherein said spacer assembly includes a second washer and a second layer of damping material located between said spacer and said second washer.

9. The hard disk drive of claim 7, wherein said first layer of damping material is located within a groove of said spacer.

10. The hard disk drive of claim 8, wherein said first layer of damping material has an undeflected thickness that is greater than a depth of said groove.

11. The hard disk drive of claim 7, wherein said spacer has an outer diameter that is approximately equal to an outer diameter of said washer.

12. The hard disk drive of claim 7, wherein said first layer of damping material is constructed from a viscoelastic material.

13. A hard disk drive, comprising:
a base plate;
a spindle motor attached to said base plate;
a first disk;
a second disk;
spacer means for separating said second disk from said first disk;
an actuator arm attached to said base plate;
a head attached to said actuator arm and coupled to said disk; and,
a voice coil motor attached to said actuator arm.

14. The hard disk drive of claim 13, wherein said spacer means includes a first layer of damping material located between a washer and a spacer.

15. The hard disk drive of claim 14, wherein said spacer means includes a second washer and a second layer of damping material located between said spacer and said second washer.

16. The hard disk drive of claim 14, wherein said first layer of damping material is located within a groove of said spacer.

17. The hard disk drive of claim 16, wherein said first layer of damping material has an uncompressed thickness that is greater than a depth of said groove.

18. The hard disk drive of claim 14, wherein said spacer has an outer diameter that is approximately equal to an outer diameter of said washer.

19. The hard disk drive of claim 14, wherein said first layer of damping material is constructed from a viscoelastic material.

20. A method for assembling a disk assembly of a hard disk drive, comprising:
placing a first disk onto a motor hub;
placing a spacer assembly onto the first disk, the spacer assembly having a first layer of damping material located between a washer and a spacer;
placing a second disk onto the spacer assembly;
clamping the spacer assembly and the first and second disks onto the motor hub.

21. The method of claim 20, wherein the first layer of damping material is deflected when the spacer assembly is clamped to the motor hub.

22. The method of claim 20, wherein the spacer assembly is placed onto the first disk by first placing the washer onto the first disk, the first layer of damping material onto the washer and then placing the spacer onto the first layer of damping material.
